(19) United States
(12) Patent Application Publication
(10) Pub. No.: US 2009/0080104 A1
(43) Pub. Date: Mar. 26, 2009

(54) INFORMATION STORAGE APPARATUS FOR DETERMINING STABILITY

(75) Inventors: Yusuke Kubota, Kawasaki (JP); Takeshi Hara, Kawasaki (JP); Yukio Abe, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/206,433

(22) Filed: Sep. 8, 2008

(30) Foreign Application Priority Data
Sep. 21, 2007 (JP) 2007-245941

(51) Int. Cl. G11B 21/02

(52) U.S. Cl. 360/75; G9B/21.003

(57) ABSTRACT

According to an aspect of an embodiment, a storage apparatus has a head for writing data into or reading data from a medium, an actuator for moving the head and a controller for applying a driving current to the actuator so as to move the head to a target position over the medium, for superimposing a disturbance current onto the driving current, the controller including a feedback loop which adjusts the driving current so as to move the head toward the target position on the basis of the position data read out from the medium by the head, the controller being configured to determine a frequency characteristic of gain and phase of the feedback loop on the basis of the driving current and the disturbance current.

### BACKGROUND

The present technique relates to a storage apparatus for storing information.

A magnetic disk apparatus has been designed and manufactured such that a mechanism (such as an actuator arm) within the magnetic disk apparatus cannot resonate for the purpose of the prevention of reduction in performance of the entire apparatus.

Among the magnetic disk apparatus manufactured in that way, some defectives exist that produce resonance due to the individual differences and/or failures in manufacturing of the magnetic disk apparatus. Therefore, manufactured magnetic disk apparatus are examined prior to shipment. The examination is performed by measuring the open loop frequency characteristic of a feedback circuit for putting a head on a target track by applying disturbance current such as sinusoidal waves to the feedback circuit. Then, the magnetic disk apparatus with a gain at a specific frequency beyond a predetermined threshold value is determined as that the magnetic disk apparatus lacks the stability and is excepted from the shipment line.

In this way, by determining the stability of a magnetic disk apparatus by using the open loop frequency characteristic of the gain, whether there is a possibility that a mechanism within the magnetic disk apparatus resonates or not and/or may not position a head normally (or oscillates) due to disturbance or not even without producing resonance can be examined.

Using only an open loop frequency characteristic of the gain of the magnetic disk apparatus causes a situation that the yield of the magnetic disk apparatus decreases since even magnetic disk apparatus having a stable internal mechanism are excepted from the shipment line. Techniques of the related art are disclosed in Japanese Laid-open Patent Publication No. 08-179802 and Japanese Laid-open Patent Publication No. 2006-221682.

### SUMMARY

According to an aspect of an embodiment, a storage apparatus has a head for writing data into or reading data from a medium, an actuator for moving the head and a controller for applying a driving current to the actuator so as to move the head to a target position over the medium, for superimposing a disturbance current onto the driving current, the controller including a feedback loop which adjusts the driving current so as to move the head toward the target position on the basis of the position data read out from the medium by the head, the controller being configured to determine a frequency characteristic of gain and phase of the feedback loop on the basis of the driving current and the disturbance current.

### BRIEF DESCRIPTION OF THE DRAWINGS

FIG. 1 is a section view of a general magnetic disk apparatus;

FIG. 2 is a block diagram showing a schematic configuration of the general magnetic disk apparatus;

FIG. 3 is a diagram for explaining a method of measuring an open loop frequency characteristic of a magnetic disk apparatus;

FIG. 4 is a diagram showing an example of the result of measurement of a gain frequency characteristic of a magnetic disk apparatus;

FIG. 5 is a diagram showing a phase frequency characteristic, which is measured from the magnetic disk apparatus from which the gain frequency characteristic shown in FIG. 4 is measured;

FIG. 6 is a diagram showing a Nyquist locus rendered based on the measurement results shown in FIGS. 4 and 5;

FIG. 7 is a diagram showing a measurement result of a Nyquist distance on the Nyquist locus shown in FIG. 6;

FIG. 8 is a diagram showing a main configuration of a magnetic disk apparatus according to a first embodiment;

FIG. 9 is a flowchart describing a routine of stability determination processing by the magnetic disk apparatus according to the first embodiment;

FIG. 10 is a diagram showing a main configuration of a magnetic disk apparatus according to a second embodiment;

FIGS. 11A and 11B are flowcharts showing a routine of stability determination processing by the magnetic disk apparatus according to the second embodiment; and

FIG. 12 is a diagram showing a main configuration of a magnetic disk apparatus according to a third embodiment.

### DESCRIPTION OF THE PREFERRED EMBODIMENTS

With reference to attached drawings, preferred embodiments of the control apparatus, storage apparatus and stability determination method according to the present technique will be described in detail below. The present technique is also effective in other storage apparatus such as a thermo-magnetic disk apparatus and opto-magnetic disk apparatus though an example in which the present technique is applied to a magnetic disk apparatus in an embodiment below. A configuration of a general magnetic disk apparatus, a method for measuring an open loop frequency characteristic of a magnetic disk apparatus, a method for determining the stability of a magnetic disk apparatus in a comparison example, a method for determining the stability of a storage apparatus according to a first embodiment and finally other embodiments will be described in order below.

### FIRST EMBODIMENT

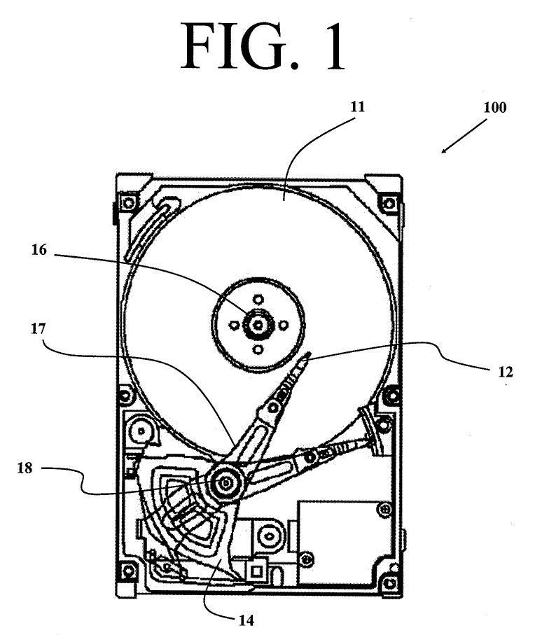

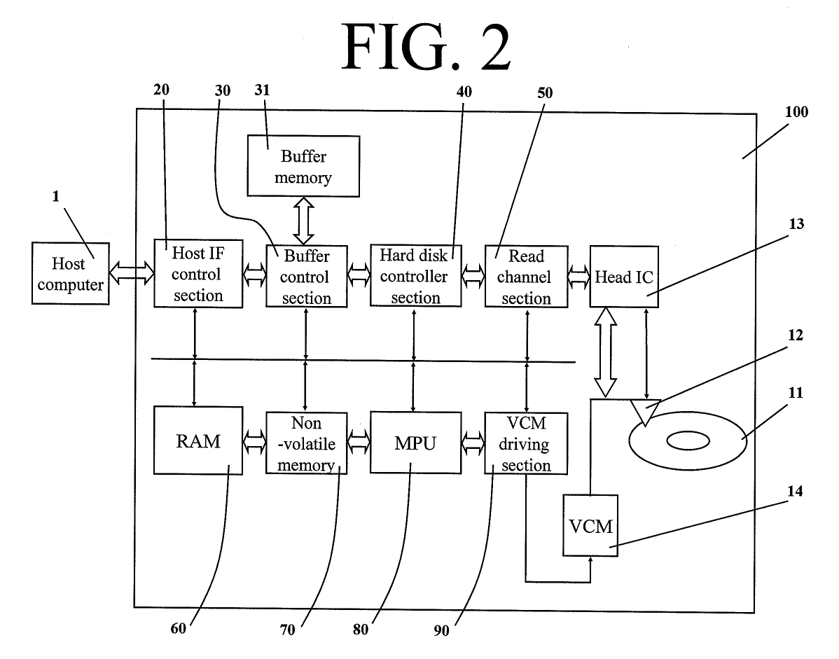

First of all, with reference to FIGS. 1 and 2, a configuration of a general magnetic disk apparatus will be described. FIG. 1 is a section view of a general magnetic disk apparatus 100. In the figure, a magnetic disk 11 is a storage medium that stores data and is driven to rotate by a spindle motor (which will be called “SPM” hereinafter) 16. Data stored in the magnetic disk 11 can be read or write with a head 12 at one end of an actuator arm 17, which is a head supporting mechanism. The head 12 performs reading or writing by keeping the state slightly levitating from a surface of the magnetic disk 11 with lift caused by the rotation of the magnetic disk 11. Driving a voice coil motor (which will be called “VCM” hereinafter) 14, which is a head driving mechanism, at the other end of the actuator arm 17 can rotate the actuator arm 17 on an arc about an axis 18. Thus, the head 12 moves to seek in the direction across tracks of the magnetic disk 11, and the track to be read or written is changed. An actuator moves the head.

FIG. 2 is a block diagram showing a schematic configuration of the general magnetic disk apparatus 100. As shown in the figure, the magnetic disk apparatus 100 includes the magnetic disk 11, the head 12, a head IC (or preamplifier IC) 13, the VCM 14, a shared bus 15, a host interface control section (which will be abbreviated to “host IF control section” hereinafter) 20, a buffer control section 30, a buffer memory 31, a hard disk controller section 40, a read channel section 50, a RAM (Random Access Memory) 60, a non-volatile memory 70, an MPU (Micro Processing Unit) 80 and a VCM driving section 90.

The magnetic disk 11 is a disk having a magnetic film on a disk-shaped substrate of metal or glass and has a system area that stores servo control data and a user area that stores user data. Here, the expression “servo control data” refers to data to be used for controlling the positioning of the head 12, and the expression “user data” refers to data to be used for processing in a host computer 1.

The head 12 includes an element that converts magnetic fields to an electric signal and reads or writes data stored on the magnetic disk 11 by levitating over the magnetic disk 11. For example, the head 12 reads the servo control data and user data magnetically stored on the magnetic disk 11, converts the servo control data and user data to electric signals and transmits the data signals to the head IC (preamplifier IC) 13. The head IC 13 preamplifies the data signals read by the head 12 and transmits the result to the read channel section 50.

Here, the head 12 must be controlled to position such that the head 12 can be positioned at a predetermined position on the magnetic disk 11 in order to read and/or write user data at the predetermined position on the magnetic disk 11. The positioning control over the head 12 can be implemented by the VCM 14, the MPU 80 and the VCM driving section 90.

The VCM 14 is a motor that is driven by the VCM driving section 90. By rotating the motor, the actuator arm 17 shown in FIG. 1 is operated to perform the positioning control over the head 12. The shared bus 15 connects to the processing sections within the magnetic disk apparatus 100 and transfers information among the processing sections.

The host IF control section 20 connects to the host computer 1, which is an upstream machine of the magnetic disk apparatus 100, and controls the communication with the host computer 1. The buffer control section 30 controls the buffer memory 31. The buffer memory 31 temporarily stores information to be exchanged between the host computer 1 and the magnetic disk apparatus 100.

The hard disk controller section 40 may check an error in data to be transferred between the host computer 1 and the magnetic disk apparatus 100. For example, the hard disk controller section 40 may receive the input of data (user data) from the host computer 1 through the host IF control section 20, add an error correction code to the data and transmit the result to the read channel section 50. For example, the hard disk controller section 40 may receive the input of data (servo control data or user data) from the read channel section 50, perform error correction thereon as required and transmit the result to the MPU 80 or the host computer 1.

The read channel section 50 amplifies the data signal outputted from the head IC 13 when the head 12 writing data into the magnetic disk 11, performs a predetermined process such as AD conversion and demodulation and performs code modulation on the data to be written on the magnetic disk 11. The RAM 60 and the non-volatile memory 70 store a firmware program that operates on the MPU 80 and/or control data.

The MPU 80 performs main control over the magnetic disk apparatus 100 and positioning control over the head 12 according to predetermined control programs (firmware program). In other words, the MPU 80 decodes a command from the host computer 1 and thus controls a processing section and centrally controls reading or writing of data onto the magnetic disk 11.

The VCM driving section 90 receives the input of a VCM control signal from the MPU 80. Based on the VCM control signal, the VCM driving section 90 generates VCM driving current for driving the VCM 14 and inputs the generated VCM driving current to the VCM 14. A controller applies the driving current to the actuator so as to move the head to a target position over the medium.

Here, the control over the positioning of the head 12 to be performed by the VCM 14, the MPU 80 and the VCM driving section 90 will be described more specifically. First of all, the MPU 80 in response to the receipt of a command from the host computer 1 decodes a command and calculates the target position on a magnetic disk for reading or writing data. The MPU 80 then receives the servo control data read from the magnetic disk 11 by the head 12 through the head IC 13, the read channel section 50 and the hard disk controller section 40 and calculates the current position of the head 12 by using the servo control data.

Then, the MPU 80 generates a VCM control signal based on the distance from the current position of the head 12 to the target position and inputs the generated VCM control signal to the VCM driving section 90. The VCM driving section 90 having received the input of the VCM control signal inputs VCM driving current to the VCM 14 and drives the VCM 14. In this way, the positioning of the head 12 is controlled.

After that, the MPU 80 performs following control (which may also be called on-track control or track following control) that controls the head 12 to put and follow the head 12 on a track of the magnetic disk 11. More specifically, after the positioning control of the head 12, the MPU 80 receives the servo control data read from the magnetic disk 11 by the head 12. Then, the MPU 80 calculates the current position of the head 12 and inputs a VCM control signal to the VCM driving section 90 such that the positional deviation between the current position and the target position can be zero. The VCM driving section 90 having received the VCM control signal inputs VCM driving current to the VCM 14 and drives the VCM 14 to move the head 12 to the target position.

In this way, by feeding back the current position (servo control data) of the head 12 to the MPU 80 after the positioning control over the head 12 is done, the driving control over the VCM 14 is performed such that the head 12 can be returned to the target position if the head 12 influenced by external force such as vibrations moves in the movable direction of the actuator arm 17 and is off-track from the target position.

Next, a method for measuring an open loop frequency characteristic of the magnetic disk apparatus 100 will be described. The expression “open loop frequency characteristic of the magnetic disk apparatus 100” refers to an open loop frequency characteristic of the internal mechanism (that is, the head 12, head IC 13, VCM 14, read channel section 50 and VCM driving section 90 in the example shown in FIG. 2) of the magnetic disk apparatus 100 that performs the feedback control if the following control is performed.

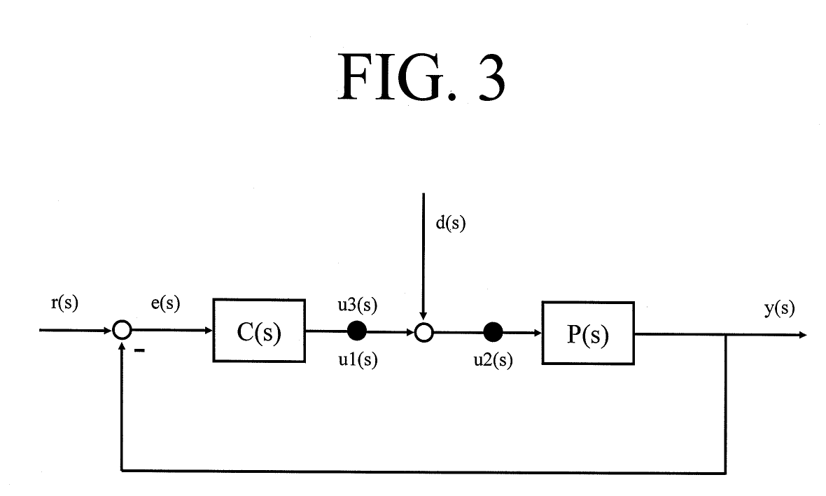

FIG. 3 is a diagram for explaining a method for measuring the open loop frequency characteristic of the magnetic disk apparatus 100. In the example shown in the figure, C(s) is an element called controller and corresponds to the VCM driving section 90 shown in FIG. 2. P(s) is a subject to be controlled and corresponds to the VCM 14 shown in FIG. 2. r(s) is a VCM control signal to be inputted from the MPU 80 when the head 12 is operated to seek.

In order to measure an open loop frequency characteristic of the magnetic disk apparatus 100, the MPU 80 causes the head 12 to perform the following operation on an arbitrary track on the magnetic disk 11. During the following operation, the VCM driving section 90 (C (s)) outputs a VCM driving current u1 (s) for moving the head 12 to a target position. In this case, the MPU 80 applies a disturbance current d (s) at the frequency, the characteristic of which is to be measured to the VCM driving current u1 (s). The VCM driving current after the application of the disturbance current (which will be called “disturbance-applied VCM driving current) u2 (s) is input to the VCM 14 (P (s)), and the head 12 is controlled to a position. The controller super imposes the disturbance current onto the driving current. The controller includes a feedback loop which adjusts the driving current so as to move the head toward the target position on the basis of the position data read out from the medium by the head. The controller determines a frequency characteristic of gain and phase of the feedback loop on the basis of the driving current and the disturbance current.

Then, the MPU 80 receives the servo control data from the head 12 under the feedback control and inputs a VCM control signal to the VCM driving section 90 such that the positional deviation between the current position of the head 12 and the target position can be zero. The VCM driving section 90 having received the VCM control signal outputs a VCM driving current u3 (s) (where the VCM driving current to be output from the VCM driving section 90 for performing positioning control again after the positioning control of the head 12 with the disturbance-applied VCM driving current will be called “recurrent VCM driving current”).

In this way, the MPU 80 changes the frequency of the disturbance current d (s) within a range to be measured, obtains the disturbance-applied VCM driving current u2 (s) and the recurrent VCM driving current u3 (s) every time and measures the open loop frequency characteristics of the magnetic disk apparatus 10 based on the u2 (s) and u3 (s).

The transmission function P (s)*C (s) may be calculated as follows:

First of all, u3 (s) is expressed as:

u3 (s)=C (s)*r (s)−C (s)*P (s)*u2 (s)

Since r (s)=0 during the following operation, the equation can be obtained as:

u3 (s)=−(C (s)*P (s)*u2 (s))

Therefore, the open-loop transmission functions, P (s)*C (s) can be obtained as:

P (s)*C (s)=−(u3 (s)/u2 (s)).

Next, a stability determination method with the magnetic disk apparatus 100 in a comparison example will be described. The description “determined as stable”, “determined as it is stable” or the like refers to the state that “determined as that there is a sufficient margin of the stability”. The description “determined as instable”, “determined as it is instable” or the like refers to the state that “determined as instable or that there is a small margin of the stability”. Stability determination processing by the magnetic disk apparatus 100 is performed in an examination step after the magnetic disk apparatus 100 is manufactured. More specifically, upon powering on the magnetic disk 100 in the examination step, the MPU 80 within the magnetic disk apparatus 100 loads and executes a stability determination program stored in the non-volatile memory 70.

When the stability determination program is executed, the MPU 80 first causes the head 12 to perform the following operation and uses the method for measuring an open loop frequency characteristic to measure the open loop frequency characteristic of the gain of the magnetic disk apparatus 100 (the open loop frequency characteristic of a gain will be called “gain frequency characteristic below).

When the gain at a specific frequency is equal to or lower than a threshold value stored in the non-volatile memory 70, there is no possibility that an internal mechanism (such as the VCM driving section 90 and the VCM 14) of the magnetic disk apparatus 100 produces resonance or oscillation. Therefore, the MPU 80 determines that the magnetic disk apparatus 100 is stable. When the gain at the specific frequency is higher than the threshold value on the other hand, there is a possibility that an internal mechanism of the magnetic disk apparatus 100 produces resonance or oscillation. Therefore, the MPU 80 determines that the magnetic disk apparatus 100 is instable.

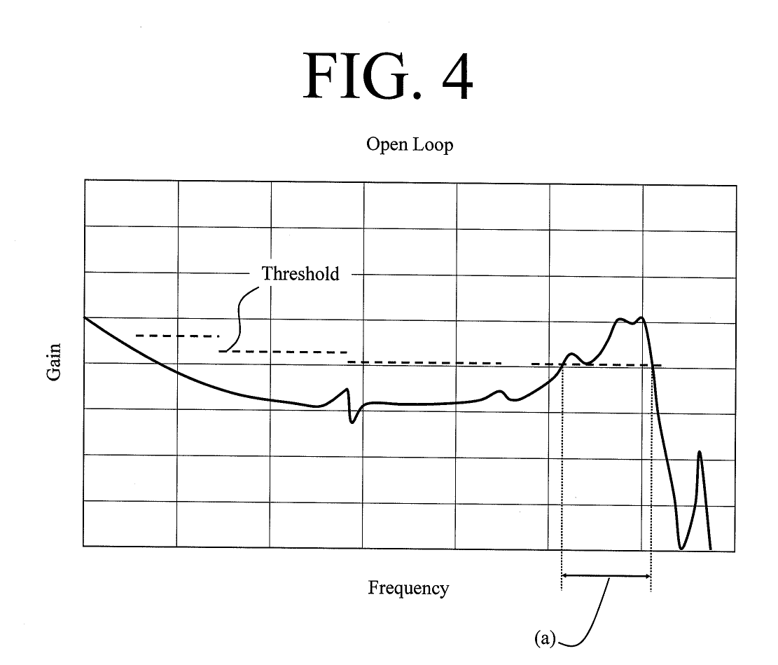

FIG. 4 is a diagram showing an example of the result of measurement of a gain frequency characteristic of the magnetic disk apparatus 100. In the example shown in the figure, the gain is higher than the threshold value at the shown frequency band (a). Therefore, the MPU 80 determines that the magnetic disk apparatus, the gain frequency characteristic of which is measured as shown in FIG. 4 is instable.

Then, after determining the stability of the magnetic disk apparatus 100, the MPU 80 instructs the hard disk controller section 40 to write data describing the stability determination result into the system area of the magnetic disk 11.

In this way, the stability determination method in the comparison example measures a gain frequency characteristic of the magnetic disk apparatus 100 and determines whether the measured gain is higher than a predetermined threshold value or not to determine the stability of the magnetic disk apparatus 100.

However, the stability determination method in the comparison example uses the gain frequency characteristic only of the magnetic disk apparatus 100 to determine the stability of the magnetic disk apparatus 100. Therefore, there is a problem that an actually stable magnetic disk apparatus 100 may be determined as instable. This excludes the stable magnetic disk apparatus 100 from a shipment line and causes the problem that the yield of the magnetic disk apparatus may be reduced.

Next, the outline of the stability determination method for a magnetic disk apparatus according to a first embodiment will be described. Stability determination processing for a magnetic disk apparatus according to the first embodiment measures an open loop frequency characteristic of a phase (which will be called “phase frequency characteristic hereinafter) of a magnetic disk apparatus 100 in addition to the gain frequency characteristic and determines the stability of the magnetic disk apparatus by using “Nyquist stability determination method”. The method for measuring an open loop frequency characteristic of a magnetic disk apparatus is the same as the aforesaid measuring method.

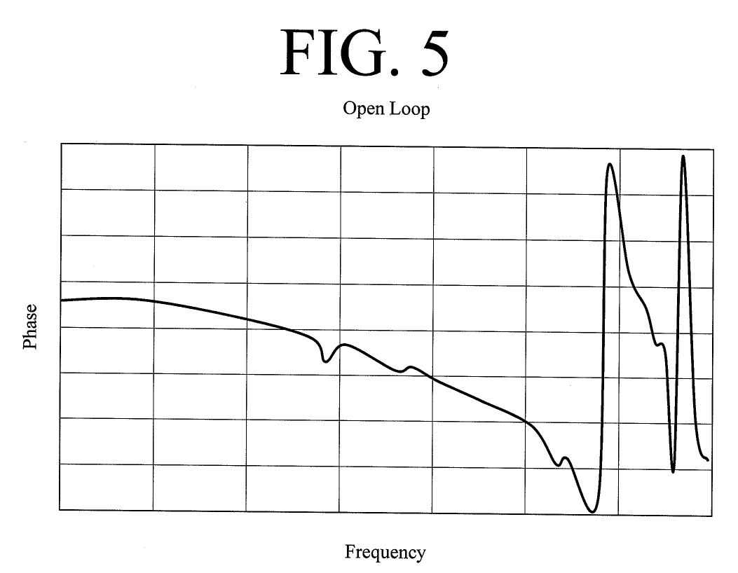

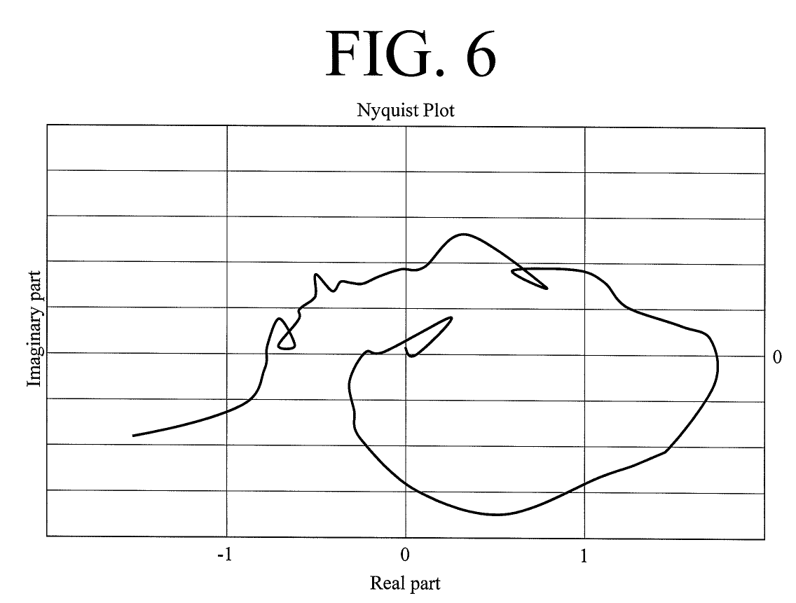

FIG. 5 is a diagram showing a phase frequency characteristic measured from the magnetic disk apparatus from which the gain frequency characteristic shown in FIG. 4 is measured. FIG. 6 is a diagram showing a Nyquist locus rendered based on the measurement results shown in FIGS. 4 and 5. The Nyquist locus shown in FIG. 6 passes through the right side of the point where (the value of the real part, the value of the imaginary part)=(−1, 0) across the real axis of a complex plane from the third quadrant to the second quadrant. Therefore, “Nyquist stability determination method” can be determined that the control-related system rendering the Nyquist locus is stable. In other words, the magnetic disk apparatus from which the measurement results shown in FIGS. 4 and 5 are obtained is stable.

As described above, the stability determination method in the comparison example determines the magnetic disk apparatus from which the measurement result shown in FIG. 4 is obtained is determined as instable. However, the “Nyquist stability determination method” determines that it is stable. A magnetic disk apparatus according to the first embodiment determines the magnetic disk apparatus as stable by focusing on the “Nyquist stability determination method”.

The stability determination method for a magnetic disk apparatus according to the first embodiment will be described more specifically. The magnetic disk apparatus according to the first embodiment actually determines the stability of the magnetic disk apparatus by determining whether the distance between the point at each frequency on the Nyquist locus rendered based on the measurement results of a gain frequency characteristic and a phase frequency characteristic and the point (−1, 0) on a complex plane is longer than a predetermined threshold or not, instead of the determination of the stability of a magnetic disk apparatus by rendering a Nyquist locus as shown in FIG. 6. (The distance between a point on a Nyquist locus and a distance at a point (−1, 0) on a plane will be called “Nyquist distance” hereinafter).

More specifically, the magnetic disk apparatus according to the first embodiment measures the value of the real part when the Nyquist locus crosses the real axis from the third quadrant to the second quadrant on a complex plane (which will be called “determination real value” hereinafter) if all Nyquist distances at the frequencies are longer than a predetermined threshold value.

When the determination real value is larger than “−1”, the magnetic disk apparatus according to the first embodiment determines that the magnetic disk apparatus is stable. When the determination real value is equal to or smaller than “−1”, it is determined that the magnetic disk apparatus is instable. On the other hand, if some Nyquist distances at frequencies are shorter than the predetermined threshold value, the magnetic disk apparatus according to the first embodiment determines that the magnetic disk apparatus is instable.

The reason for measuring the determination real value is that the determination of the stability based on the Nyquist distances may not determine an instable control system, which can be determined according to the “Nyquist stability determination method”, when the Nyquist locus passes through the minus side of the real axis about the point (−1, 0) on a complex plane.

By measuring the Nyquist distances at frequencies and the determination real value in this way, the form of the Nyquist locus to be rendered can be determined, and, as a result, the stability of the magnetic disk apparatus can be determined by using the “Nyquist stability determination method”.

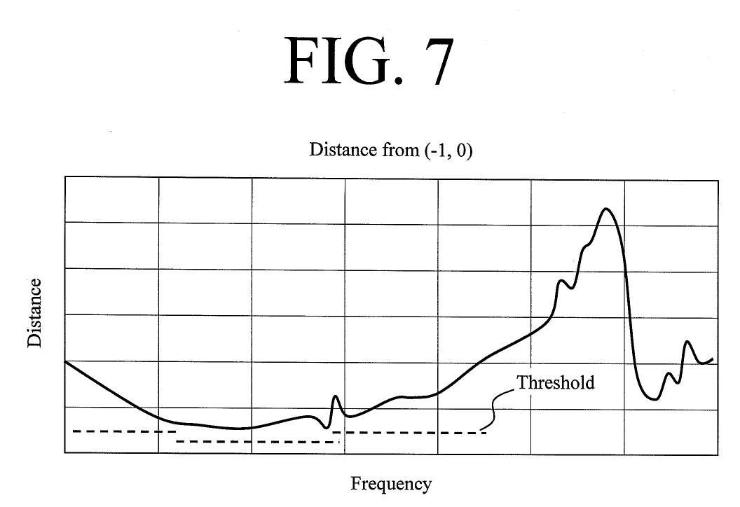

FIG. 7 is a diagram showing measurement results of Nyquist distances on the Nyquist locus shown in FIG. 6. In the example shown in the figure, since there are no frequencies at which the Nyquist distances are shorter than the threshold value, it is determined that the magnetic disk apparatus the Nyquist distances of which are measured as shown in the figure is stable.

As described above, the magnetic disk apparatus according to the first embodiment measures a gain frequency characteristic and a phase frequency characteristic and determines the stability of the magnetic disk apparatus by using the “Nyquist stability determination method”, which is a method for determining the stability of a control-related system therein. Therefore, the stability of the magnetic disk apparatus can be determined more precisely than the stability determination method in the comparison example. In other words, the number of frequencies of misjudgment of actually stable disk apparatus as instable can be reduced, and the yield of the magnetic disk apparatus can be improved as a result.

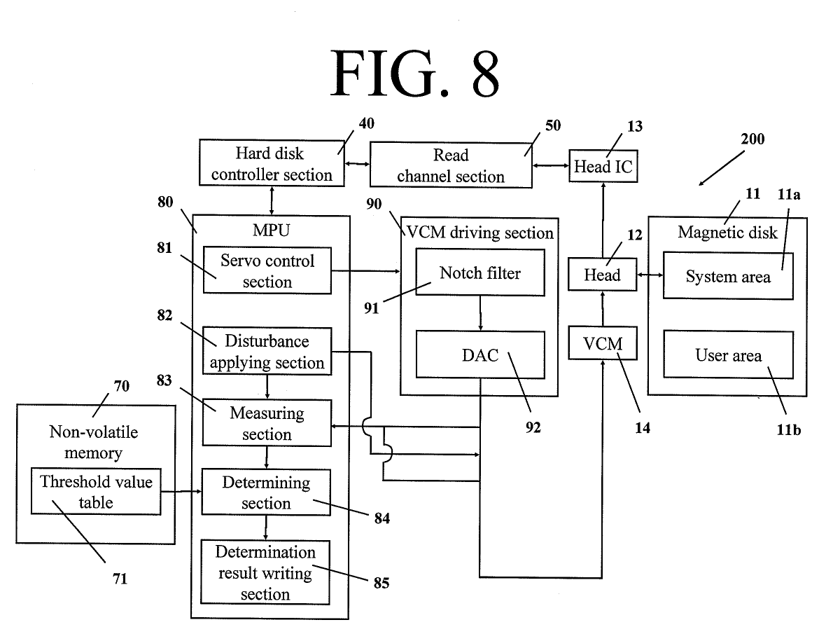

Next, a main configuration of a magnetic disk apparatus 200 according to the first embodiment will be described. The schematic configuration of the magnetic disk apparatus 200 is identical to the schematic configuration of the magnetic disk apparatus 100 shown in FIG. 2. FIG. 8 is a diagram showing a main configuration of the magnetic disk apparatus 200 according to the first embodiment. As shown in the figure, a magnetic disk 11 has a system area 11a and a user area 11b. The system area 11a stores servo control data and a stability determination result. The user area lib stores user data.

A non-volatile memory 70 has a threshold table 71. The threshold table 71 stores a threshold for Nyquist distances having stability. In order to obtain the threshold value, Nyquist distances from multiple stable magnetic disk apparatus are measured, and the average of the measurement results may be defined. The threshold value may be one same value for all frequencies or may be different values among predetermined frequency bands. The threshold value may be stored in the system area 11a though the first embodiment describes an example that the threshold value for Nyquist distances is stored in the non-volatile memory 70.

An MPU 80 has a servo control section 81, a disturbance applying section 82, a measuring section 83, a determining section 84 and a determination result writing section 85. The MPU 80 may be an MCU (or Micro Controller Unit) or a CPU (or a Central Processing Unit).

The servo control section 81 is a processing section that controls the positioning of a head 12 at a predetermined position over the magnetic disk 11. More specifically, the servo control section 81 uses servo control data read by the head 12 to calculate the current position of the head 12, generates a VCM control signal based on the distance from the current position of the head 12 to a target position and inputs the generated VCM control signal to the VCM driving section 90. The servo control section 81 inputs the VCM control signal during a following control operation to the VCM driving section 90 such that the positional deviation between the current position of the head 12 and the target position can be zero.

The disturbance applying section 82 is a processing section that applies a disturbance current such as sinusoidal waves at a frequency the characteristic of which is to be measured to the VCM driving current outputted by the VCM driving section 90. The measuring section 83 is a processing section that obtains the disturbance-applied VCM driving current and a recurrent VCM driving current, measures the gain frequency characteristic and phase frequency characteristic and measures a Nyquist distance from the measurement results.

The determining section 84 is a processing section that determines the stability of the magnetic disk apparatus 200 and outputs the stability determination result to the determination result writing section 85. More specifically, the determining section 84 measures a determination real value when all Nyquist distances at frequencies, which are measured by the measuring section 83, are longer than a threshold value stored in the threshold value table 71. When the determination real value is higher than “−1”, the determining section 84 determines that the magnetic disk apparatus 200 is stable. When the determination real value is equal to or lower than “−1”, it is determined that the magnetic disk apparatus 200 is instable.

On the other hand, when some Nyquist distances at frequencies, which are measured by the measuring section 83, are shorter than the threshold value stored in the threshold table 71, the determining section 84 determines that the magnetic disk apparatus 200 is instable.

The determination result writing section 85 is a processing section that receives the stability determination result from the determining section 84 and instructs a hard disk controller section 40 to write the stability determination result into the system area 11a.

The VCM driving section 90 has a notch filter 91 and a digital-analog converter (which will be called “DAC” hereinafter) 92. The notch filter 91 rapidly attenuates partial frequency bands of the VCM control signals inputted from the servo control section 81 and outputs the VCM control signals to the DAC 92. The DAC 92 converts the VCM control signals (which are digital signals) from the notch filter 91 to a VCM driving current (which is an analog signal) and outputs a VCM driving current to the VCM 14.

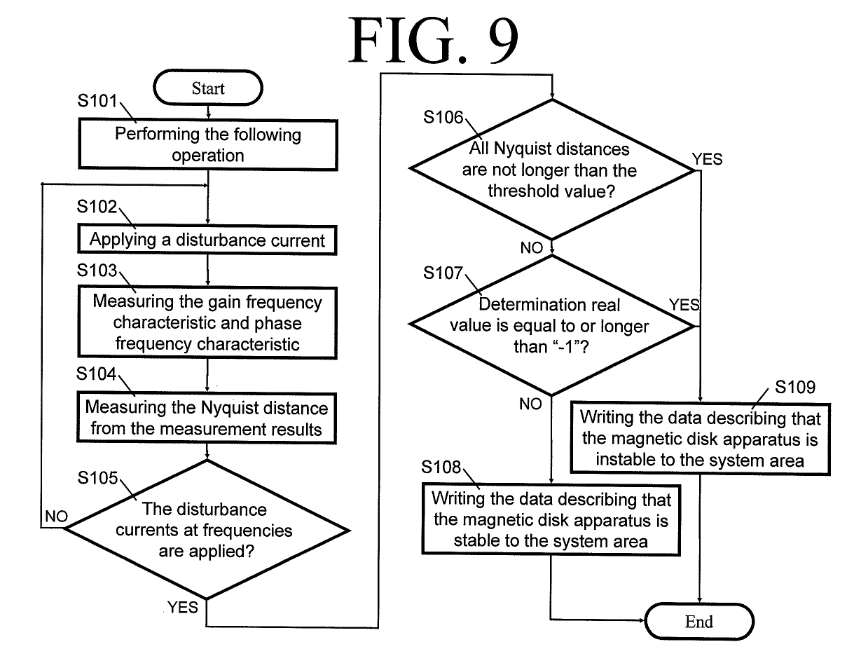

Next, the stability determination processing by the magnetic disk apparatus 200 according to the first embodiment will be described. FIG. 9 is a flowchart describing a stability determination processing routine by the magnetic disk apparatus 200 according to the first embodiment.

Upon powering on the magnetic disk apparatus 200 in the examination step, the MPU 80 loads and executes a stability determination program stored in the non-volatile memory 70. Then, as shown in the figure, the MPU 80 causes the head 12 to perform the following operation on an arbitrary track on the magnetic disk 11 (step S101).

Then, the disturbance applying section 82 applies a disturbance current at a frequency the characteristic of which is to be measured to the VCM driving current outputted from the VCM driving section 90 (step S102). After that, when the disturbance-applied VCM driving current is inputted to the VCM 14 and the head 12 is controlled to position, the servo control section 81 receives the servo control data read from the system area 11a by the head 12 and inputs a VCM control signal to the VCM driving section 90 such that the positional deviation from the target position can be zero. Then, the recurrent VCM driving current is outputted from the VCM driving section 90.

The measuring section 83 obtains the disturbance-applied VCM driving current and the recurrent VCM driving current, measures the gain frequency characteristic and phase frequency characteristic (step S103) and measures the Nyquist distance from the measurement results (step S104).

Until the disturbance currents at all frequencies the characteristics of which are to be measured are finished to apply (negative in step S105), the disturbance applying section 82 applies the disturbance currents at the changed frequencies, the characteristics of which are to be measured to the VCM driving current output from the VCM driving section 90 (step S102). Then, the measuring section 83 measures the gain frequency characteristics and the phase frequency characteristics (step S103) and measures the Nyquist distances from the measurement results (step S104).

When the disturbance currents at all frequencies the characteristics of which are to be measured are applied (positive in step S105), the determining section 84 determines the stability of the magnetic disk apparatus 200 based on the Nyquist distances at the frequencies subject to the measurement by the measuring section 83.

More specifically, the determining section 84 measures the determination real value when all Nyquist distances are longer than the threshold value stored in the threshold value table 71 (negative in step S106). Then, when the determination real value is higher than “−1” (negative in step S106), the determining section 84 determines that the magnetic disk apparatus 200 is stable and outputs the stability determination result to the determination result writing section 85.

The determination result writing section 85 having received the stability determination result writes the data describing that the magnetic disk apparatus 200 is stable into the system area 11a through the hard disk controller section 40, a read channel section 50, a write deriver of a head IC 13 and the head 12 (step S108).

On the other hand, when some Nyquist distances at the frequencies subject to the measurement by the measuring section 83 are shorter than the threshold value stored in the threshold table 71 (positive in step S106), when all Nyquist distances are longer than the threshold value (negative in step S106) or when the determination real value is equal to or lower than “−1” (positive in step S107), the determining section 84 determines that the magnetic disk apparatus 200 is instable and outputs the stability determination result to the determination result writing section 85.

The determination result writing section 85 having received the stability determination result writes the data that the magnetic disk apparatus 200 is instable into the system area 11a through the hard disk controller section 40, the read channel section 50, the write driver of the head IC 13 and the head 12 (step S109).

As described above, the magnetic disk apparatus 200 according to the first embodiment is configured to measure the gain frequency characteristic and phase frequency characteristic of the magnetic disk apparatus 200 and use the “Nyquist stability determination method” to determine the stability of the magnetic disk apparatus 200. Therefore, the stability of the magnetic disk apparatus 200 can be determined precisely.

### SECOND EMBODIMENT

Having described the example according to the first embodiment in which, when the magnetic disk apparatus 200 is determined as instable, the data describing that the magnetic disk apparatus 200 is instable is written into the system area 11a, a second embodiment will be described with reference to an example in which, when a magnetic disk apparatus is determined as instable, the filter characteristic of a notch filter 91 is changed to perform stability determination processing again.

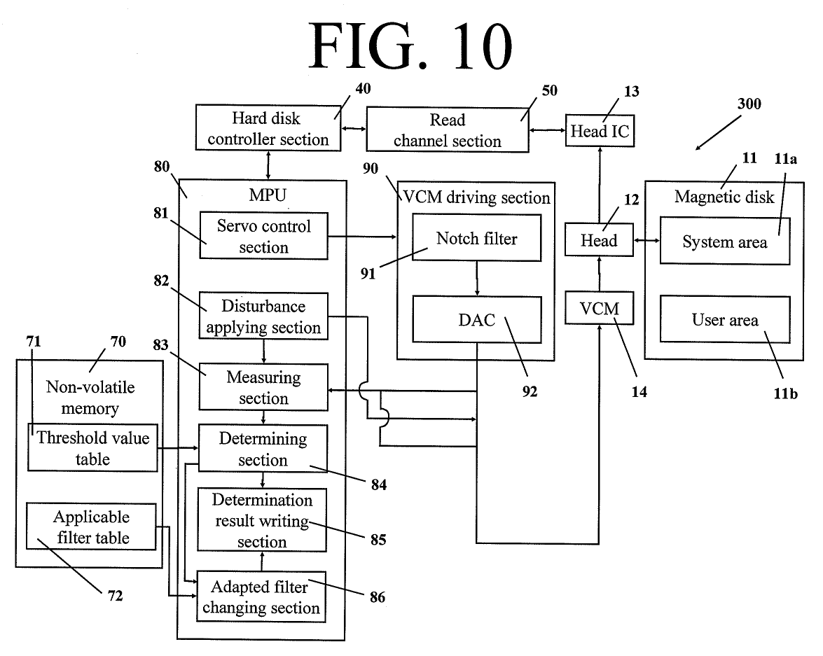

FIG. 10 is a diagram showing a main configuration of a magnetic disk apparatus 300 according to the second embodiment. The schematic configuration of the magnetic disk apparatus 300 is identical to the schematic configuration of the magnetic disk apparatus 100 shown in FIG. 2. As shown in FIG. 10, a non-volatile memory 70 further includes an applicable filter table 72, compared with the non-volatile memory 70 according to the first embodiment.

The applicable filter table 72 stores multiple candidate filter coefficient patterns to be applied to the notch filter 91. The filter coefficient pattern to be applied to the notch filter 91 is stored as applicable pattern data in the system area 11a.

An MPU 80 further includes an adapted filter changing section 86, compared with the MPU 80 according to the first embodiment. The adapted filter changing section 86 changes the applied pattern data stored in the system area 11a and causes to perform stability determination processing again through a hard disk controller section 40, a read channel section 50, a head IC 13 and a head 12 when the determining section 84 determines that the magnetic disk apparatus 200 is instable. The adapted filter changing section 86 further outputs information describing the fact that all of the patterns are tried to the notch filter 91 when all of the patterns stored in the applicable filter table 72 are applied to the notch filter 91.

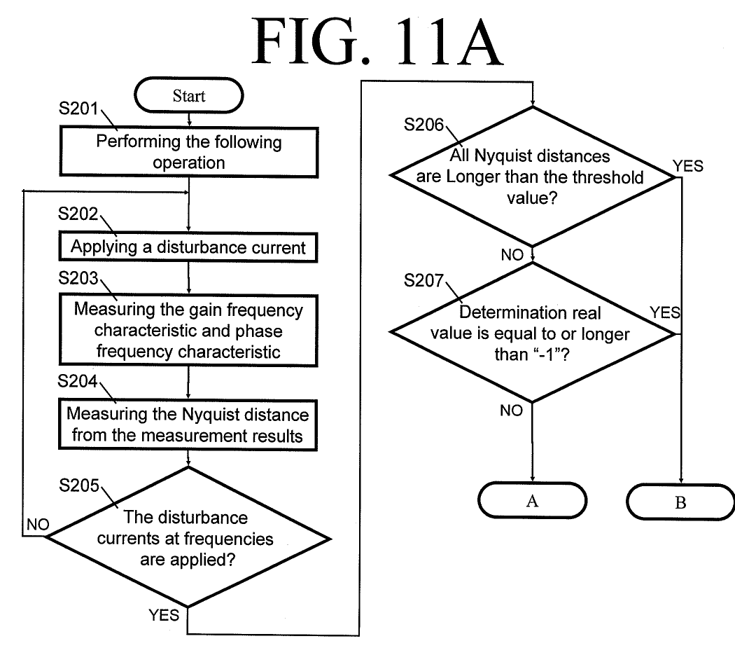

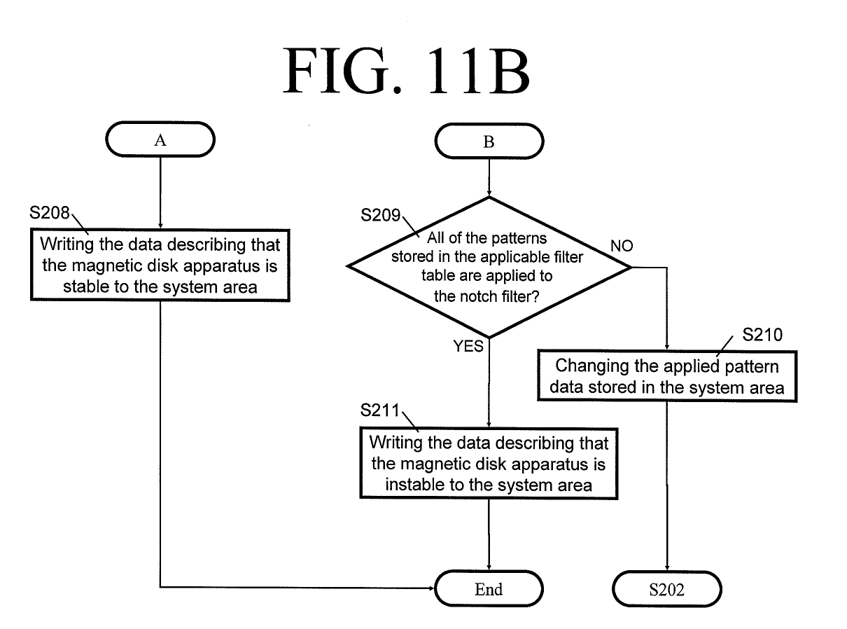

Next, stability determination processing by the magnetic disk apparatus 300 according to the second embodiment will be described. FIGS. 11A and 11B are flowcharts describing a stability determination processing routine by the magnetic disk apparatus 300 according to the second embodiment. Since the processing routine shown in the figure includes the same steps (that is, steps S201 to S205) until the processing of measuring a Nyquist distance in the stability determination processing routine shown in FIG. 9, the descriptions thereon will be omitted herein.

As shown in FIGS. 11A and 11B, when some Nyquist distances at frequencies subject to the measurement by the measuring section 83 are shorter than a threshold value stored in the threshold value table 71 (positive in step S206) or when the determination real vale is equal to or lower than “−1” (positive in step S207), the determining section 84 determines that the magnetic disk apparatus 300 is instable and outputs the stability determination result to the adapted filter changing section 86.

When all of the patterns stored in the applicable filter table 72 are not applied to the notch filter 91 (negative in step S209), the adapted filter changing section 86 having received the stability determination result changes the applied pattern data stored in the system area 11a (step S210) and causes to perform the stability determination processing again (step S202).

On the other hand, when all of the patterns stored in the applicable filter table 72 are applied to the notch filter 91 (positive in step S209), the adapted filter changing section 86 outputs information describing that all of the patterns are tried to the notch filter 91 to the determination result writing section 85. The determination result writing section 85 having received the information writes the data describing that the magnetic disk apparatus 300 is instable into the system area 11a through the hard disk controller section 40, the read channel section 50, the write driver of the head IC 13 and the head 12 (step S211).

As described above, when it is determined that the magnetic disk apparatus 300 is instable, the magnetic disk apparatus 300 according to the second embodiment is configured to change the filter characteristic of the notch filter 91 and perform the stability determination processing again. Therefore, there is a possibility that the magnetic disk apparatus 300 determined as instable can be redressed, and, as a result, the yield of the magnetic disk apparatus can be improved.

### THIRD EMBODIMENT

Having described the example according to the second embodiment in which, when the magnetic disk apparatus 300 is determined as instable, the filter characteristic of the notch filter 91 is changed, a third embodiment will be described with reference to an example in which the band of an MPU 80 within a magnetic disk apparatus is lowered. The term “band” herein refers to a frequency at which the gain in the open loop frequency characteristic of a magnetic disk apparatus is “0” dB.

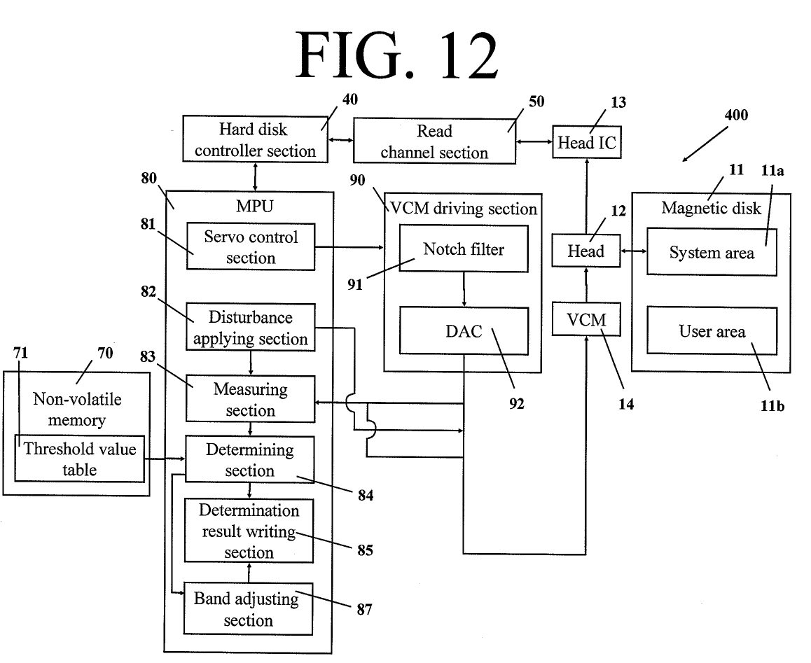

FIG. 12 is a diagram showing a main configuration of a magnetic disk apparatus 400 according to the third embodiment. The schematic configuration of the magnetic disk apparatus 400 is identical to the schematic configuration of the magnetic disk apparatus 100 shown in FIG. 2. As shown in FIG. 12, an MPU 80 further includes a band adjusting section 87 instead of the adapted filter changing section 86, compared with the MPU 80 according to the second embodiment.

The band adjusting section 87 is a processing section that lowers the band of the MPU 80 of the magnetic disk apparatus 400 and causes to perform stability determination processing again. More specifically, when the determining section 84 determines that the magnetic disk apparatus 400 is instable, the band adjusting section 87 lowers the coefficients (parameters) of (comparison, integral and differential) elements for PID (Proportional Integral Derivative) control included in a part of following control to be implemented by the MPU 80. By lowering the coefficients of the elements for the PID control, the band of the MPU 80 can be lowered. Therefore, there is a possibility that the resonance or oscillation can be prevented in an internal mechanism of the magnetic disk apparatus 400.

The band adjusting section 87 lowers the coefficients of the elements for the PID control within a predetermined range and causes to perform stability determination processing again. When it is not determined that the magnetic disk apparatus 400 is stable even by continuously lowering the coefficients of the elements for the PID control within the predetermined range, the determination result writing section 85 determines that the magnetic disk apparatus 400 is instable.

As described above, the magnetic disk apparatus 400 according to the third embodiment is configured to lower the band of the MPU 80 and perform stability determination processing again when it is determined that the magnetic disk apparatus 400 is instable. Therefore, there is a possibility that the magnetic disk apparatus 400 determined as instable can be redressed, and, as a result, the yield of the magnetic disk apparatus can be improved.

The magnetic disk apparatus according to the second and third embodiments may perform stability determination processing not only in the examination step prior to shipment but also during standby or immediately after the start even after shipment. Thus, the stability of a storage apparatus can be kept, and the number of durable years can be increased as a result even in a case where there is a possibility that resonance or oscillation may be produced by a change in frequency characteristic due to secular changes of a magnetic disk apparatus after shipment. Notably, the expression “during standby” refers to the state where reading or writing is not performed without input of any command from a host computer to a magnetic disk apparatus.

As described above, the control apparatus, storage apparatus and stability determination method according to the present technique are effective for determining the stability of the storage apparatus and are particularly suitable for a case where the stability of the storage apparatus must be determined precisely. It is further suitable for a case where the magnetic disk apparatus determined as instable as a result of the determination of the stability of the storage apparatus must be redressed.

According to an aspect of the present technique, the stability of a storage apparatus can be determined precisely. In other words, the number of frequencies of misjudgment of actually stable storage apparatus as instable can be reduced, resulting in the advantage that the yield of the storage apparatus can be improved.

According to the aspects of the present technique, there is a possibility that the storage apparatus determined as instable can be redressed, and the yield of storage apparatus can be improved as a result.

According to the aspects of the present technique, the stability of a storage apparatus can be kept, and the number of durable years can be increased as a result even in a case where there is a possibility that resonance or oscillation may be produced by a change in frequency characteristic due to secular changes of a storage apparatus after shipment.

What is claimed is:

1. A storage apparatus comprising:
a head for writing data into or reading data from a medium;
an actuator for moving the head; and
a controller for applying a driving current to the actuator so as to move the head to a target position over the medium, for superimposing a disturbance current onto the driving current, the controller including a feedback loop which adjusts the driving current so as to move the head toward the target position on the basis of the position data read out from the medium by the head, the controller being configured to determine a frequency characteristic of gain and phase of the feedback loop on the basis of the driving current and the disturbance current.

2. The storage apparatus of claim 1, wherein the controller measures a Nyquist distance, which is a distance between a point on a Nyquist locus and a point where a value of a real part on a complex plane is -1 and a value of an imaginary part is 0, for each frequency in a case where the Nyquist locus is rendered based on the determined frequency characteristic of gain and phase.

3. The storage apparatus of claim 2, wherein the controller determines the stability of the storage apparatus on the basis of the Nyquist distance measured.

4. The storage apparatus of claim 3, wherein the controller determines that the storage apparatus is stable when all Nyquist distances at frequencies measured are longer than a threshold value and determines that the storage apparatus is instable when some Nyquist distances at frequencies measured are shorter than the threshold value.

5. The storage apparatus of claim 3, wherein the controller changes a filter characteristic of the actuator such that a predetermined frequency band of the driving current to be inputted being able to be attenuated when the storage apparatus is instable.

6. The storage apparatus of claim 3, wherein the controller lowers a band when the storage apparatus is instable.

7. A method of controlling a storage apparatus having a head for writing data into or reading data from a medium and an actuator for moving the head, comprising:
applying a driving current to the actuator so as to move the head to a target position over the medium;
superimposing a disturbance current onto the driving current;
including a feedback loop which adjusts the driving current so as to move the head toward the target position on the basis of the position data read out from the medium by the head; and
determining a frequency characteristic of gain and phase of the feedback loop on the basis of the driving current and the disturbance current.

8. The method of claim 7, further comprising measuring a Nyquist distance, which is a distance between a point on a Nyquist locus and a point where a value of a real part on a complex plane is −1 and a value of the imaginary part is 0, for each frequency in a case where the Nyquist locus is rendered based on the determined frequency characteristic of gain and phase.

9. The method of claim 8, further comprising determining the stability of the storage apparatus on the basis of the Nyquist distance measured.

10. The method of claim 9, further comprising determining that the storage apparatus is stable when all Nyquist distances at frequencies measured are longer than a threshold value and determines that the storage apparatus is instable when some Nyquist distances at frequencies measured are shorter than the threshold value.

11. The method of claim 9, further comprising changing a filter characteristic of the actuator such that a predetermined frequency band of the driving current to be inputted being able to be attenuated when the storage apparatus is instable.

12. The method of claim 9, further comprising lowering a band when the storage apparatus is instable.

13. A controller for controlling a storage apparatus having a head for writing data into or reading data from a medium and an actuator for moving the head, comprising:
an applying unit for applying a driving current to the actuator so as to move the head to a target position over the medium;
a superimposing unit for superimposing a disturbance current onto the driving current; and
a determining unit for determining a frequency characteristic of gain and phase of a feedback loop which adjusts the driving current so as to move the head toward the target position on the basis of the position data read out from the medium by the head, on the basis of the driving current and the disturbance current.

14. The controller of claim 13, further comprising a measuring unit for measuring a Nyquist distance, which is a distance between a point on a Nyquist locus and a point where a value of a real part on a complex plane is −1 and a value of an imaginary part is 0, for each frequency in a case where the Nyquist locus is rendered based on the determined frequency characteristic of gain and phase.

15. The controller of claim 14, wherein the determining unit determines the stability of the storage apparatus on the basis of the Nyquist distance measured.
